(19) United States
(12) Patent Application Publication
(10) Pub. No.: US 2026/0362199 A1
(43) Pub. Date: Nov. 12, 2026

(54) TRUNCATED EVENT-TRIGGERED MEASUREMENT REPORT GENERATION

(71) Applicant: QUALCOMM Incorporated, San Diego, CA (US)

(72) Inventors: Doohyun SUNG, Basking Ridge, NJ (US); Jelena DAMNJANOVIC, Del Mar, CA (US); Ozcan OZTURK, San Diego, CA (US); Sitaramanjaneyulu KANAMARLAPUDI, San Diego, CA (US)

(21) Appl. No.: 19/462,757

(22) Filed: Jan. 28, 2026

Related U.S. Application Data
(60) Provisional application No. 63/801,602, filed on May 7, 2025.

(51) Int. Cl. H04W 24/10; H04W 24/08

(52) U.S. Cl. CPC H04W 24/10; H04W 24/08

(57) ABSTRACT

Various aspects of the present disclosure generally relate to wireless communication. In some aspects, a user equipment (UE) may select, for inclusion in one or more truncated medium access control (MAC) control element (CE) (MAC-CE) measurement reports, one or more beam measurements or beam types. The UE may transmit the one or more truncated MAC-CE measurement reports that include the one or more beam measurements or beam types selected. The UE may transmit, via a MAC-CE, an indication of one or more pending measurement reports or one or more pending beam results. Numerous other aspects are described.

### CROSS-REFERENCE TO RELATED APPLICATION

This Patent Application claims priority to U.S. Provisional Patent Application No. 63/801,602, filed on May 7, 2025, entitled “TRUNCATED EVENT-TRIGGERED MEASUREMENT REPORT GENERATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with truncated measurement reports.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless networks rely on measurement reports to evaluate and improve network performance. Measurement reports include information such as received signal strength, reference signal received power, reference signal received quality, signal-to-noise ratio, or interference level. Measurement reports may be transmitted by a user equipment (UE) to a network node, and the UE may be configured with uplink resources for transmitting the measurement report.

### SUMMARY

The systems, methods, and devices of this disclosure each have several innovative aspects, no single one of which is solely responsible for the desirable attributes disclosed herein.

Some aspects described herein relate to a user equipment (UE). The UE may include one or more antennas and a processing system. The processing system may include one or more processors and one or more code-storing memories coupled with the one or more processors. The processing system may be configured to cause the UE to select, for inclusion in one or more truncated medium access control (MAC) control element (MAC-CE) measurement reports, one or more beam measurements or beam types. The processing system may cause the UE to transmit the one or more truncated MAC-CE measurement reports that include the one or more beam measurements or beam types selected. The processing system may be configured to cause the UE to transmit, via a MAC-CE, an indication of one or more pending measurement reports or one or more pending beam results.

Some aspects described herein relate to a network node. The network node may include a processing system. The processing system may include one or more processors and one or more code-storing memories coupled with the one or more processors. The processing system may be configured to cause the network node to receive, from a UE, one or more truncated MAC-CE measurement reports. The processing system may be configured to cause the network node to receive, from the UE and via a MAC-CE, an indication of one or more pending measurement reports or one or more pending beam results as a result of an event-level truncation or a beam-level truncation.

Some aspects described herein relate to a method of wireless communication performed by a UE. The method may include selecting, for inclusion in one or more truncated MAC-CE measurement reports, one or more beam measurements or beam types. The method may include transmitting the one or more truncated MAC-CE measurement reports that include the one or more beam measurements or beam types selected. The method may include transmitting, via a MAC-CE, an indication of one or more pending measurement reports or one or more pending beam results.

Some aspects described herein relate to a method of wireless communication performed by a network node. The method may include receiving, from a UE, one or more truncated MAC-CE measurement reports. The method may include receiving, from the UE and via a MAC-CE, an indication of one or more pending measurement reports or one or more pending beam results as a result of an event-level truncation or a beam-level truncation.

Some aspects described herein relate to a non-transitory computer-readable medium that stores a set of instructions for wireless communication by a UE. The set of instructions, when executed by one or more processors of the UE, may cause the UE to select, for inclusion in one or more truncated MAC-CE measurement reports, one or more beam measurements or beam types. The set of instructions, when executed by one or more processors of the UE, may cause the UE to transmit the one or more truncated MAC-CE measurement reports that include the one or more beam measurements or beam types selected. The set of instructions, when executed by one or more processors of the UE, may cause the UE to transmit, via a MAC-CE, an indication of one or more pending measurement reports or one or more pending beam results.

Some aspects described herein relate to a non-transitory computer-readable medium that stores a set of instructions for wireless communication by a network node. The set of instructions, when executed by one or more processors of the network node, may cause the network node to receive, from a UE, one or more truncated MAC-CE measurement reports. The set of instructions, when executed by one or more processors of the network node, may cause the network node to receive, from the UE and via a MAC-CE, an indication of one or more pending measurement reports or one or more pending beam results as a result of an event-level truncation or a beam-level truncation.

Some aspects described herein relate to an apparatus for wireless communication. The apparatus may include means for selecting, for inclusion in one or more truncated MAC-CE measurement reports, one or more beam measurements or beam types. The apparatus may include means for transmitting the one or more truncated MAC-CE measurement reports that include the one or more beam measurements or beam types selected. The apparatus may include means for transmitting, via a MAC-CE, an indication of one or more pending measurement reports or one or more pending beam results.

Some aspects described herein relate to an apparatus for wireless communication. The apparatus may include means for receiving, from a UE, one or more truncated MAC-CE measurement reports. The apparatus may include means for receiving, from the UE and via a MAC-CE, an indication of one or more pending measurement reports or one or more pending beam results as a result of an event-level truncation or a beam-level truncation.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example associated with truncated medium access control (MAC) control element (MAC-CE) measurement report generation.

FIG. 3 is a diagram illustrating an example process performed, for example, at a user equipment (UE) or an apparatus of a UE.

FIG. 4 is a diagram illustrating an example process performed, for example, at a network node or an apparatus of a network node.

FIGS. 5-6 are diagrams of example apparatuses for wireless communication.

FIGS. 7-9 are diagrams illustrating example bits of MAC-CE measurement reports.

### DETAILED DESCRIPTION

In wireless communication systems, the ability to efficiently manage and report measurement data helps maintain network performance. Measurement reporting is one technique that allows network devices, such as user equipment (UE), to communicate quality metrics back to the network infrastructure, such as a base station, gNB, or other network node.

Measurement reports triggered by specific events, such as changes in signal quality, are referred to as event-triggered reports. Other measurement reports may be triggered by a defined set of conditions. Examples include measurement reports indicating that a neighboring cell's signal is superior to that of a current serving cell. Such reports are typically managed at Layer 3 (L3) using radio resource control (RRC) signaling.

One of the primary challenges arises from a limited size of physical uplink shared channel (PUSCH) grants. In scenarios where multiple measurement events are triggered simultaneously, or where a single event involves a large number of beams, the available uplink grant may be insufficient for the UE to transmit all the intended measurement data. When the PUSCH grant is too small, the UE may transmit a truncated measurement report, either at the event level (where entire events are omitted) or at the content level (where some beam measurements within an event are omitted).

The truncation of measurement reports can lead to several complications. Firstly, the network (e.g., the gNB) lacks information on whether additional resources are needed to complete the transmission of pending measurement reports. This can result in inefficient resource allocation and potential degradation in network performance due to incomplete or delayed reporting. Moreover, when measurement reports are truncated, it can be unclear whether certain types of beams (for example, beams that do not trigger specific events) should be prioritized for inclusion in subsequent reports.

Additionally, the use of differential reference signal received power (RSRP) reporting, which relies on encoding relative signal strength differences, can be problematic when the reference beam (e.g., the beam with the highest RSRP) is not included as the first entry in the measurement report. This affects the accuracy and utility of the differential encoding, which is designed to optimize bit usage by representing other beams' RSRP values relative to the strongest beam.

Furthermore, wireless network standards do not give the UE an opportunity to indicate to the network that a truncated report contains pending data, which would require further uplink grants for complete transmission. This lack of signaling can lead to inefficiencies in the network's handling of uplink resources, as it cannot proactively allocate additional resources to address incomplete transmissions.

Various aspects relate generally to managing truncated measurement reports in wireless communication systems. Some aspects more specifically address the challenges of transmitting complete measurement data when uplink resources are limited. In some aspects, a UE may transmit truncated medium access control (MAC) control element (MAC-CE) measurement reports, indicating pending measurement reports or beam results due to event-level or beam-level truncation. In some aspects, the UE provides separate indications for pending reports and beam results, while in other aspects, the UE may transmit a single indication to indicate both scenarios. With the indication, the network can determine that additional uplink grants are needed for the UE to complete transmission of the measurement reports.

In some aspects, the UE transmits an indication of how many truncations have occurred, whether at the event or beam level, enabling the network to better manage uplink resources. The UE may also include beam type indications in the truncated reports, selecting beams based on priority, uplink grant size, or the number of beams that can be reported. The measurement reports may include absolute or differential RSRP values, with differential values potentially incorporating positive or negative offsets. Additionally, in some aspects, the UE may declare when all newly triggered beams have been reported, even if some data has not been transmitted due to truncation.

Particular aspects of the subject matter described in this disclosure can be implemented to realize one or more of the following potential advantages. By providing explicit indications of pending data and the extent of truncation, the described techniques allow the network to efficiently allocate additional resources, ensuring complete transmission of measurement data. This reduces the risk of incomplete reports affecting network decisions, such as handovers or resource allocation, thereby conserving network resources. Additionally, by allowing for differential RSRP values with positive offsets, the system can maintain accuracy in signal strength reporting even when the reference beam is not the strongest, which can optimize bit usage and maintain report utility. Further, by allowing UEs to declare completion of beam reporting when all critical data is sent, unnecessary transmissions can be avoided, further conserving network resources and enhancing overall system efficiency. In this way, the solution may conserve processing resources, memory resources, network resources, or a combination thereof, among other examples.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

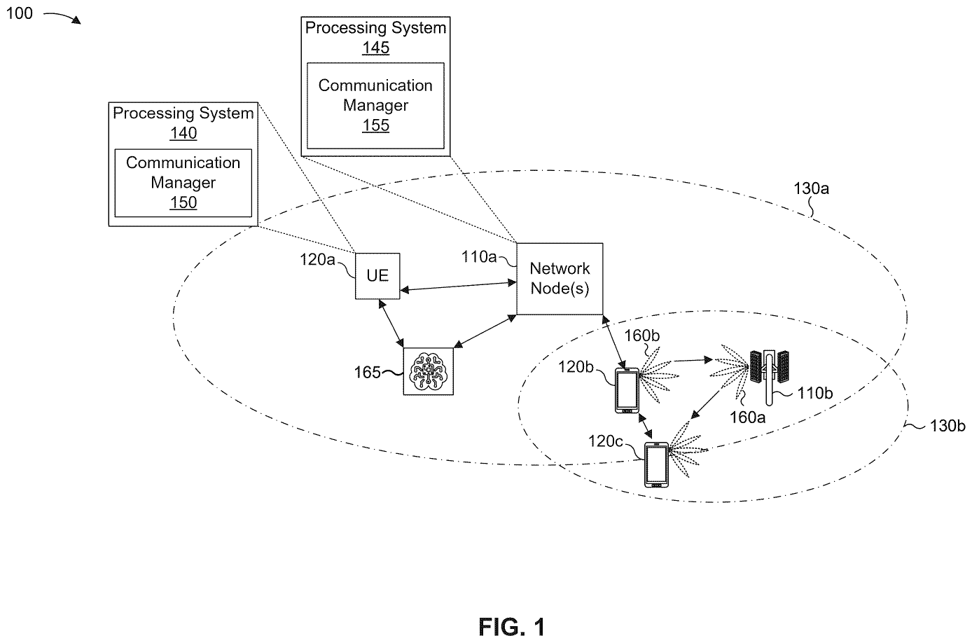

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may select, for inclusion in one or more truncated MAC-CE measurement reports, one or more beam measurements or beam types; transmit the one or more truncated MAC-CE measurement reports that include the one or more beam measurements or beam types selected; and transmit, via a MAC-CE, an indication of one or more pending measurement reports or one or more pending beam results. Additionally, or alternatively, the communication manager 150 may perform one or more other operations described herein.

In some aspects, the network node 110 may include a communication manager 155. As described in more detail elsewhere herein, the communication manager 155 may receive, from a UE, one or more truncated MAC-CE measurement reports; and receive, from the UE and via a MAC-CE, an indication of one or more pending measurement reports or one or more pending beam results as a result of an event-level truncation or a beam-level truncation. Additionally, or alternatively, the communication manager 155 may perform one or more other operations described herein.

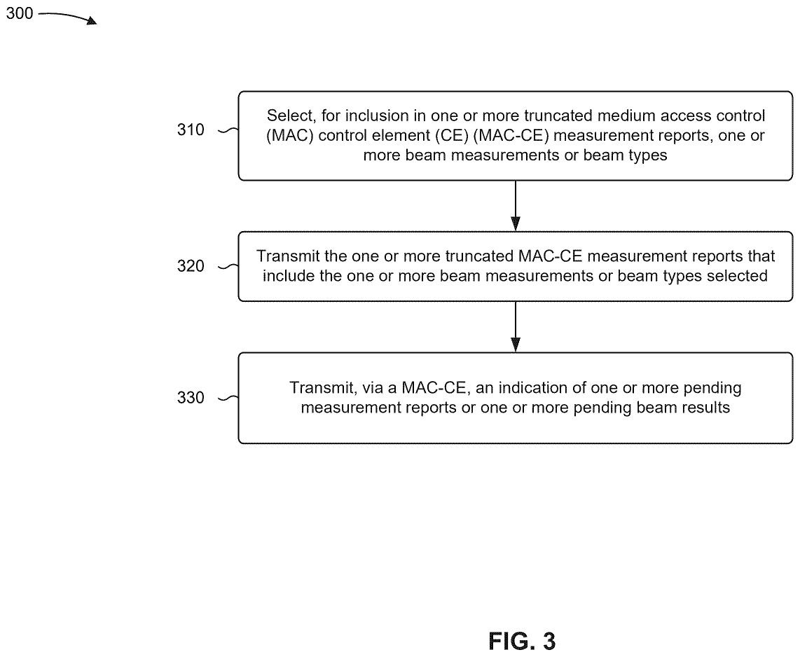

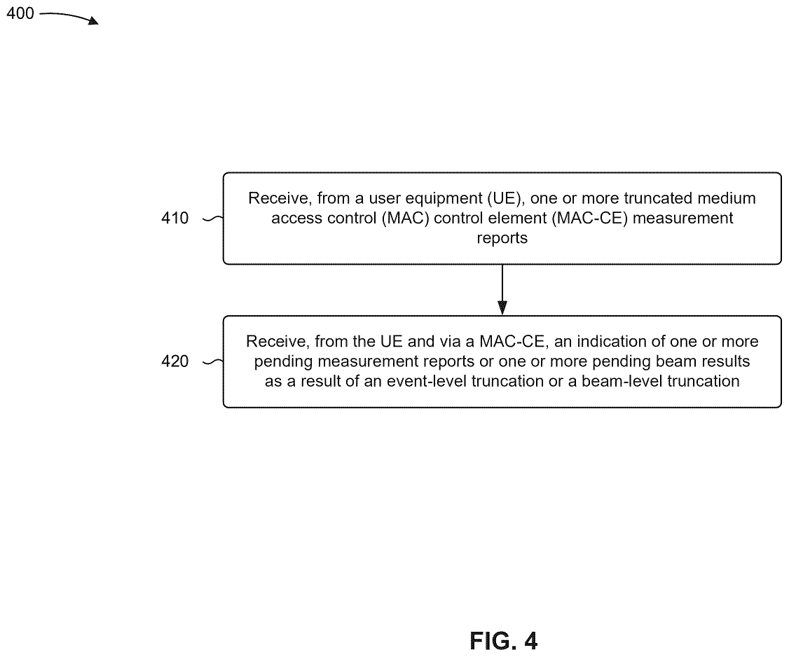

The network node 110, the processing system 145 of the network node 110, the UE 120, the processing system 140 of the UE 120, or any other component(s) of FIG. 1 may implement one or more techniques or perform one or more operations associated with truncated MAC-CE measurement reporting, as described in more detail elsewhere herein. For example, the processing system 145 of the network node 110, or the processing system 140 of the UE 120 may perform or direct operations of, for example, process 300 of FIG. 3, process 400 of FIG. 4, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 300 of FIG. 3, process 400 of FIG. 4, or other processes as described herein. In some examples, executing instructions may include running the instructions, converting the instructions, compiling the instructions, or interpreting the instructions, among other examples.

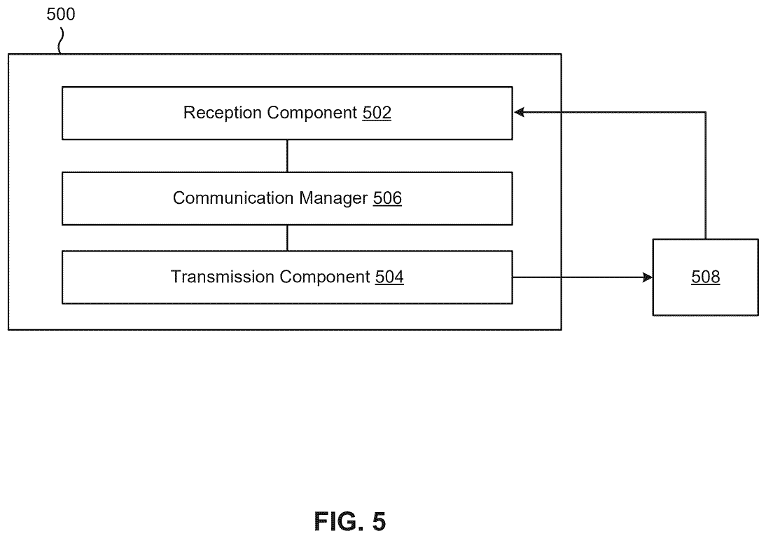

In some aspects, the UE 120 includes means for selecting, for inclusion in one or more truncated MAC-CE measurement reports, one or more beam measurements or beam types; means for transmitting the one or more truncated MAC-CE measurement reports that include the one or more beam measurements or beam types selected; or means for transmitting, via a MAC-CE, an indication of one or more pending measurement reports or one or more pending beam results. The means for the UE 120 to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

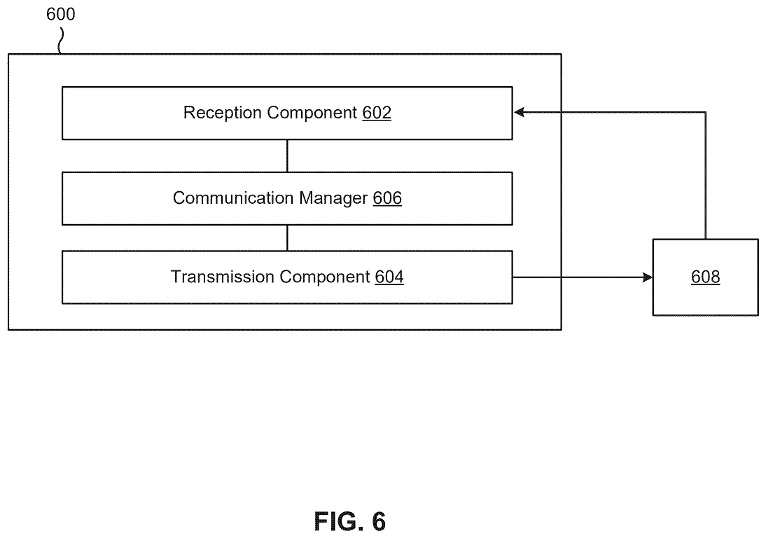

In some aspects, the network node 110 includes means for receiving, from a UE (e.g., UE 120), one or more truncated MAC-CE measurement reports; or means for receiving, from the UE and via a MAC-CE, an indication of one or more pending measurement reports or one or more pending beam results as a result of an event-level truncation or a beam-level truncation. The means for the network node 110 to perform operations described herein may include, for example, one or more of communication manager 155, processing system 145, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

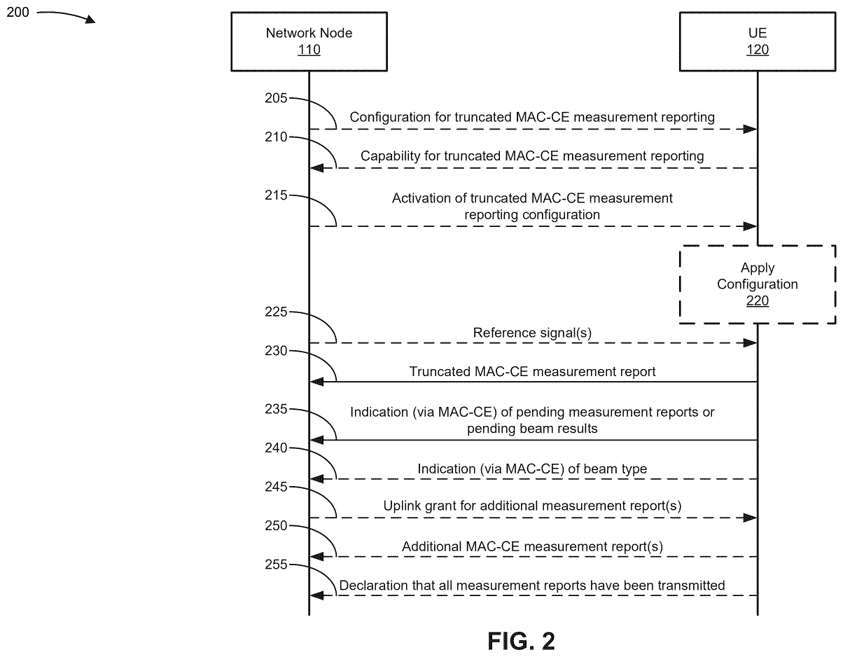

FIG. 2 is a diagram illustrating an example 200 associated with truncated MAC-CE measurement report generation. As shown in FIG. 2, a network node 110 and a UE 120 may communicate with one another.

In some aspects, as shown by reference number 205, the network node 110 may transmit, and the UE 120 may receive, a configuration for truncated MAC-CE measurement reporting. For example, the network node 110 may establish one or more configurations, parameters, or rules that allow the UE 120 to truncate one or more measurement reports transmitted, from the UE 120 to the network node 110 via MAC-CE. In some aspects, truncating a measurement report means the UE 120 may omit (e.g., refrain from transmitting) one or more beam measurements or measurement reports despite an occurrence of an event that would otherwise trigger the UE 120 to transmit one or more measurement reports with the one or more beam measurements. In some aspects, the configuration for truncated MAC-CE measurement reporting may configure the UE 120 to truncate measurement reports when, for example, an uplink grant is insufficient for the UE 120 to transmit a complete (e.g., a non-truncated) measurement report.

In some aspects, as shown by reference number 210, the UE 120 may transmit, and the network node 110 may receive, one or more capability indications. In some aspects, the one or more capability indications may indicate support, by the UE 120, for the configuration for truncated measurement reporting.

In some aspects, as shown by reference number 215, the network node 110 may transmit, and the UE 120 may receive, an activation signal. In some aspects, the activation signal may cause the UE 120 to apply the configuration for the truncated MAC-CE measurement reporting. In some aspects, the activation signal may be transmitted to the UE 120 via RRC signaling or MAC-CE signaling.

In some aspects, instead of configuring the UE 120 for truncated MAC-CE measurement reporting, the network node 110 may dynamically adjust measurement reporting parameters by, for example, updating an uplink grant availability that provides sufficient resources for the UE 120 to transmit a non-truncated measurement report via MAC-CE signaling. Dynamically adjusting the measurement reporting parameters may allow the network node 110 to respond to real-time conditions, thereby optimizing the use of limited resources. Alternatively or in addition, the UE 120 may be configured to prioritize certain measurement data (e.g., measurement data for beams having a first beam type) over others during reporting, allowing for measurements of higher priority beams to be transmitted ahead of data on lower priority beams (e.g., beams having a second beam type) when uplink resources are limited. By prioritizing data in accordance with beam type, the UE 120 may truncate measurement reports while communicating the most significant measurement data to the network node 110, even when uplink resources are limited. Alternatively or in addition, rather than activating a specific configuration for truncated measurement reporting, the UE 120 may be configured to automatically switch between regular (e.g., non-truncated) and truncated reporting modes based on real-time uplink channel assessments. By automatically switching between regular and truncated reporting modes, the UE 120 may adaptively manage measurement reporting to improve communication efficiency.

In some aspects, as shown by reference number 220, the UE 120 may apply the configuration for truncated measurement reporting. In some aspects, applying the configuration for truncated measurement reporting may include applying one or more parameters for transmitting different MAC-CE indications for the one or more pending measurement reports and for the one or more pending beam results. The indication may be defined in one or both of a regular MAC-CE and a truncated MAC-CE. In some aspects, the UE 120 may be configured to transmit separate indication bits for pending measurement reports and pending beam results. For example, a first bit or a first bit pair may indicate that the UE 120 can send one or more pending measurement reports and a second bit or a second bit pair may indicate that the UE 120 can send one or more pending beam results. In some aspects, a first bit pair (e.g., “00”) may indicate that the UE 120 did not truncate any pending measurement reports or beam results. A second bit pair (e.g., “01”) may indicate that the UE 120 truncated a measurement report, and therefore has a pending measurement report to transmit, but truncate any beam results. A third bit pair (e.g., “10”) may indicate that the UE 120 did not truncate any measurement reports but truncated one or more beam results, meaning the UE 120 has one or more pending beam results to transmit. A fourth bit pair (e.g., “11”) may indicate that the UE 120 truncated one or more measurement reports and one or more beam results, meaning the UE 120 has one or more pending measurement reports and one or more pending beam results to transmit. Alternatively, in some aspects, the UE 120 may transmit a common indication bit to signal whether subsequent uplink resource allocation is needed for the pending measurement reports, the pending beam results, or both, without explicitly differentiating between the pending measurement reports and the pending beam results.

In some aspects, the indication may be a 3-bit indication. For example, in some aspects, the 3-bit indication may include a first bit indicating a whether a beam report is pending and a second bit and a third bit indicating whether a beam result is pending. In addition, the second bit and the third bit may indicate which part of a truncated beam result has been transmitted. For example, a first bit sequence (e.g., “000”) may indicate that the UE 120 has no pending beam reports and no pending beam measurement results to report (e.g., the MAC-CE measurement report was a non-truncated MAC-CE measurement report). A second bit sequence (e.g., “001”) may indicate that the UE 120 has a pending beam report to transmit but no beam measurement results to transmit. A third bit sequence (e.g., “100”) may indicate that there are no pending beam reports, but one or more parts of a truncated beam result are available. A fourth bit sequence (e.g., “101”) may indicate that a pending beam report is available and that a last part of a truncated beam result has been transmitted, indicating that no additional pending beam results are available. A fifth bit sequence (e.g., “110”) may indicate that there are no pending beam reports and that a middle part of a truncated beam result is available, indicating that pending beam results are present. A sixth bit sequence (e.g., “111”) may indicate that a pending beam report exists and a middle part of a truncated beam result exists, signifying that pending beam results are present.

In some aspects, the UE 120 may be configured to indicate a quantity of truncations that have occurred. For example, the UE 120 may truncate a measurement report into multiple truncated MAC-CE segments, and each truncated MAC-CE segment may carry a segment index that indicates a position of the measurement report within a sequence of truncated segments. A maximum number of truncated segments may be configured by one or more RRC parameters by the network node 110. Upon reaching the configured maximum number of truncated MAC-CE segments, the UE 120 may discontinue transmission of additional truncated MAC-CE segments. In some aspects, the UE 120 may configure itself in accordance with a timer that may be started by the UE 120 upon transmission of each truncated MAC-CE segment. The UE 120 may be configured to discard any remaining truncated MAC-CE segments upon expiry of the timer.

In some aspects, the UE 120 may be configured with one or more parameters for beam selection and RSRP representation when generating truncated MAC-CE measurement reports. For example, in some aspects, the UE 120 may apply a combination of RSRP value formats, beam type filtering, and ordered beam selection to maximize the utility of each uplink transmission opportunity while respecting the PUSCH grant size. Accordingly, the UE 120 may be configured to provide the most relevant beam measurements to the network node 110 while making the network node 110 aware of any remaining measurement reports or beam results that could not be sent in a single MAC-CE segment.

To truncate the MAC-CE measurement report, the UE 120 may be configured to select one of multiple RSRP reporting schemes. In some aspects, the UE 120 may be configured to report absolute RSRP values for all selected beams. Alternatively, in some aspects, the UE 120 may be configured to report an absolute RSRP for newly triggered beams (e.g., for Type 1 and Type 2 beams) or for beams previously indicated as newly triggered beams (e.g., Type 3 beams) and report a differential RSRP for any remaining beams (e.g., for Type 3 and Type 4 beams or for only Type 4 beams), with the beams ordered from strongest (e.g., highest RSRP) to weakest (e.g., lowest RSRP) in the truncated MAC-CE measurement report. In some aspects, the differential values may be encoded using either both positive and negative offsets or negative-only offsets to reduce bit width. Alternatively, in some aspects, the UE 120 may be configured to use the same differential RSRP representation used in regular (e.g., non-truncated) MAC-CE measurement reports, which may allow seamless reuse of existing encoding tables.

In some aspects, the UE 120 may configure itself to apply a beam-type filter. For example, the UE 120 may be configured to apply, before populating the truncated MAC-CE measurement report, a beam-type filter that is defined in accordance with configuration received via RRC or defined in a wireless communication specification. In some aspects, the UE 120 may be configured to report only newly triggered beams (e.g., Type 1 and Type 2 beams) to immediately indicate, to the network node 110, measurements corresponding to new or recent events. Alternatively, in some aspects, the UE 120 may be configured to include information about beams that are included in a triggered beam list (e.g., Type 3 beams). Alternatively, in some aspects, the configuration for truncated MAC-CE measurement reports may configure the UE 120 to report measurements for all beams, including beams that do not satisfy any event conditions (e.g., Type 4 beams).

In some aspects, the UE 120 may configure itself with one or more rules or parameters that allow the UE 120 to determine a quantity of beams to include in the truncated MAC-CE measurement report when a PUSCH grant cannot accommodate measurements for all beams. In some aspects, the UE 120 may be configured to groups measurements by beam type and order the groups by priority. In some aspects, the UE 120 may be configured to assign a highest priority to newly triggered beams (e.g., Type 1 and Type 2 beams), an intermediate priority to Type 3 beams, and a lowest priority to Type 4 beams. Within each group, the UE 120 may be configured to sort individual beam measurements in descending order of RSRP. In some aspects, the UE 120 may be configured to select the top N number of beams across the ordered groups, where N may be determined in accordance with the available PUSCH grant size and a maximum reportable beam count. In some aspects, the UE 120 may be configured to update or override one or more configurations for beam type priority or beam selection within a beam type. In some aspects, the UE 120 may be configured to autonomously (e.g., without permission from the network node 110) update or override one or more configurations for beam type priority or beam selection. In some aspects, the UE 120 may update or override the beam type priority or beam selection in accordance with a measurement history, cell switch history, AI/ML prediction data, or a combination thereof, among other examples. In some aspects, the ability of the UE 120 to update or override the beam type priority or beam selection may be subject to a UE capability, and the network node 110 may be configured to transmit signaling, to the UE 120, that allows or disallows the UE 120 to autonomously update or override the beam type priority or beam selection.

If beam reordering is supported, the UE 120 may be configured to reorder the selected beams by RSRP before applying a differential encoding. For example, when a differential RSRP (negative only) value is applied to N beams, the first beam entry may indicate a highest RSRP. If reordering is not supported, and the first entry may not be the strongest beam, the UE 120 may be configured to indicate, via a MAC-CE, to the network node 110 that positive offsets, negative offsets, or both, may be used to indicate the RSRP values of each beam. For example, a truncated MAC CE may have an indicator that informs the network that the first entry does not have the highest RSRP value. When the indictor indicates that the first entry does have the highest RSRP value, a modified differential RSRP table can be realized as a differential RSRP table that allows positive offset as well as negative offset. Alternatively, in some aspects, a positive offset may be applied to an existing differential RSRP table. In some aspects, the positive offset may be defined via a wireless communication specification or configured by RRC signaling.

In some aspects, the UE 120 may be configured to transmit one or more truncated MAC-CE measurement reports for a triggered event. In some aspects, the UE 120 may be configured to transmit a separate MAC-CE declaring that the reporting of that event is complete. The UE 120 may generate the declaration in accordance with the truncated MAC-CE measurement reporting configuration, and may transmit the declaration without transmitting any additional truncated MAC-CE measurement reports once the completion condition is met, even if the UE 120 has not sent one or more truncated MAC-CE measurement reports. In some aspects, the conditions under which the UE 120 may transmit the completion declaration may be defined in a wireless communication specification or may be configured by an RRC signal from the network node 110. In some aspects, the UE 120 may be configured to transmit the declaration when all newly triggered beams (e.g., Type 1 and Type 2 beams) have been included in one or more truncated MAC-CE measurement reports. In some aspects, the UE 120 may be configured to transmit the declaration when newly triggered beams (e.g., Type 1 and Type 2 beams) and all other beams maintained in a triggered-beam list (e.g., Type 3 beams) have been included in one or more truncated MAC-CE measurement reports. By transmitting a distinct completion declaration, the UE 120 may inform the network node 110 that no further uplink resources are required for reporting the triggered event. The declaration may be transmitted in a MAC-CE format corresponding to the format for truncated MAC-CE measurement reports and may use a dedicated bit or codepoint to signal completion of the event's measurement reporting. Alternatively, in some aspects, the UE 120 may declare that a triggered event report transmission is complete without transmitting a declaration to the network node 110. For example, declaring that the triggered event report transmission is complete may include the UE 120 setting a flag or parameter.

In some aspects, the UE 120 may apply a configuration for multiplexing residual content from a previously truncated Layer 1 (L1) measurement report with a truncated MAC-CE measurement report for another triggered event within a single MAC-CE transmission. For example, when the UE 120 determines that the uplink grant cannot accommodate all segments of a current event-triggered MAC-CE measurement report, the UE 120 may preserve one or more pending MAC-CE measurement report segments and, upon generation of another measurement report (e.g., a new measurement report) for a subsequent event, the UE 120 may concatenate pending MAC-CE measurement report segments with the new measurement report. The combined MAC-CE may be then transmitted to the network node 110 in one uplink grant, and the network node 110 may parse the multiplexed MAC-CE to recover the MAC-CE measurement report segment and the new measurement report. With this configuration, the UE 120 may transmit fewer uplink communications while minimizing reporting latency, resulting in improved resource efficiency in event-triggered measurement reporting.

In some aspects, as shown by reference number 225, the network node 110 may transmit, and the UE 120 may receive, one or more reference signals. For example, the UE may receive signals that assist in determining beam quality and direction. The one or more reference signals may include one or more SSB transmissions identified by an SSBRI, CSI-RS transmissions identified by a CRI, or a combination thereof, among other examples. The UE 120 may measure an RSRP value for each of the one or more reference signals in accordance with the truncated MAC-CE measurement reporting configuration.

In some aspects, as shown by reference number 230, the UE may transmit, and the network node 110 may receive, one or more truncated MAC-CE measurement reports. For example, the UE 120 may transmit a partial set of measurement results when transmitting a non-truncated measurement report is not possible due to resource constraints. Each truncated MAC-CE measurement report may include a report configuration identity corresponding to a triggered measurement event, one or more beam identifiers, and corresponding L1 RSRP values. The beam identifiers may include an SSB reference index or a CRI, as discussed above. In some aspects, the RSRP values may include either an absolute RSRP value or a differential RSRP value computed relative to a reference beam in accordance with the truncated MAC-CE measurement report configuration, as discussed above. In some aspects, the UE 120 may select which beam measurements to include in the truncated MAC-CE measurement report in accordance with the truncated MAC-CE measurement reporting configuration.

In some aspects, as shown by reference number 235, the UE may transmit, and the network node 110 may receive, via a MAC-CE, an indication of one or more pending measurement reports or one or more pending beam results as a result of an event-level truncation or a beam-level truncation. For example, the UE 120 may signal to the network that additional reporting is required for one or more beams that were not included in the truncated MAC-CE measurement report. By receiving the indication of the one or more pending measurement reports, the network node 110 may allocate resources for additional measurement reporting, thereby providing the network node 110 with more information that the network node 110 may use to manage operation of the network. In some aspects, transmitting the indication may include transmitting different MAC-CE indications for the one or more pending measurement reports and for the one or more pending beam results. For example, the UE 120 may use separate indication fields to specify pending status for different report types. Transmitting different indications for different pending statuses may facilitate more precise resource allocation by the network node 110. Additionally or alternatively, transmitting the indication may include transmitting a single indication for the one or more pending measurement reports and the one or more pending beam results. For example, the UE 120 may use a unified indication value to represent all pending reports in a compact format. Using a single indication for all pending reports may simplify the signaling process and reduce signaling overhead. In some aspects, the indication may indicate a quantity of truncations, and the quantity of truncations may include one or more of a quantity of event-level truncations or a quantity of beam-level truncations. For example, the UE may include numerical values in the indication to specify how many reports were truncated at event or beam levels. Indicating truncation quantities may assist the network in understanding the extent of reporting limitations and plan resource distribution accordingly.

In some aspects, as shown by reference number 240, the UE 120 may transmit, and the network node 110 may receive, a beam type indication for one or more beam types included in the one or more truncated MAC-CE measurement reports. For example, the UE 120 may specify which types of beams (e.g., Type 1, Type 2, Type 3, Type 4, or a combination thereof, among other examples) are included in the truncated MAC-CE measurement report based on the measurement priority.

In some aspects, as shown by reference number 245, the network node 110 may transmit, and the UE 120 may receive, an uplink grant for transmitting one or more pending measurement reports or beam results. For example, the network node 110 may allocate one or more additional resources for the UE 120 to transmit one or more additional truncated MAC-CE measurement reports. With the uplink grant, the UE 120 may transmit comprehensive measurement data to the network.

In some aspects, as shown by reference number 250, the UE 120 may transmit, and the network node 110 may receive, one or more additional truncated MAC-CE measurement reports. In some aspects, the UE 120 may select, for inclusion in at least one of the one or more additional truncated MAC-CE measurement reports, one or more beam measurements or beam types, and the one or more beam measurements or beam types may be selected in accordance with a priority of each of the one or more beam measurements or beam types, a quantity of beams that can be reported, or a physical uplink shared channel grant size. For example, the UE 120 may prioritize the reporting of beams with higher signal strength or relevance based on the available uplink grant size. By selecting beam measurements or beam types according to priority, the UE 120 may optimize the reporting process to allow the most critical data to be communicated to the network. Alternatively or in addition, in some aspects, the one or more selected beams may be ordered in at least one of the one or more truncated MAC-CE measurement reports by RSRP. For example, the UE 120 may sort the beams in descending order of RSRP. Ordering beams by RSRP may allow the network to quickly identify and manage network operations using the strongest signal sources.

In some aspects, as shown by reference number 255, the UE 120 may transmit, and the network node 110 may receive, a declaration indicating that all newly triggered beams have been reported. For example, the UE 120 may inform the network node 110 that measurement reports for all relevant beams have been transmitted, which may confirm to the network node 110 that measurement reporting is complete to prevent unnecessary resource allocation for additional reporting. In some aspects, the declaration indication may be transmitted without transmitting at least one of the one or more truncated MAC-CE measurement reports. For example, the UE 120 may skip sending certain truncated measurement reports while still indicating completion of measurement reporting.

The techniques described above may be applied individually or in combination across multiple L1 MR MAC-CE scenarios, including event-triggered regular (e.g., non-truncated) measurement reporting, event-triggered truncated measurement reporting, periodic regular measurement reporting, and periodic truncated measurement reporting. In some aspects, the UE 120 may use the indication, truncation, and multiplexing mechanisms for different RRC configurations and reporting periodicities. Furthermore, in some aspects, the concepts disclosed herein may support multiple beam classification schemes (e.g., three-class grouping (e.g., a group including Type 1 and Type 3 beams, a group including Type 2 beams, and a group including Type 4 beams) or four-class grouping (e.g., where Type 1 beams, Type 2 beams, Type 3 beams, and Type 4 beams are in different groupings)). With multiple beam classification schemes, the UE 120 may flexibly select and order beam measurements according to the priority and RSRP metrics before packaging the measurements into truncated or regular MAC-CEs. Accordingly, the techniques described herein may result in measurement reports that are reliably communicated to the network node 110 in a variety of reporting contexts.

As indicated above, FIG. 2 is provided as an example. Other examples may differ from what is described with respect to FIG. 2.

FIG. 3 is a diagram illustrating an example process 300 performed, for example, at a UE or an apparatus of a UE. Example process 300 is an example where the apparatus or the UE (e.g., UE 120) performs operations associated with truncated event-triggered measurement report generation.

As shown in FIG. 3, in some aspects, process 300 may include selecting, for inclusion in one or more truncated MAC-CE measurement reports, one or more beam measurements or beam types (block 310). For example, the UE (e.g., using communication manager 506 depicted in FIG. 5) may select one or more of the beam measurements or beam types for inclusion in the one or more truncated MAC-CE measurement reports.

As further shown in FIG. 3, in some aspects, process 300 may include transmitting the one or more truncated MAC-CE measurement reports that include the one or more beam measurements or beam types selected (block 320). For example, the UE (e.g., using transmission component 504 or communication manager 506, depicted in FIG. 5) may transmit one or more truncated MAC-CE measurement reports, as described above.

As further shown in FIG. 3, in some aspects, process 300 may include transmitting, via a MAC-CE, an indication of one or more pending measurement reports or one or more pending beam results (block 330). For example, the UE (e.g., using transmission component 504 or communication manager 506, depicted in FIG. 5) may transmit, via a MAC-CE, an indication of one or more pending measurement reports or one or more pending beam results, as described above.

Process 300 may include additional aspects, such as any single aspect or any combination of aspects described below or in connection with one or more other processes described elsewhere herein.

In a first aspect, transmitting the indication includes transmitting different MAC-CE indications for the one or more pending measurement reports and for the one or more pending beam results.

In a second aspect, alone or in combination with the first aspect, transmitting the indication includes transmitting a single indication for the one or more pending measurement reports and the one or more pending beam results.

In a third aspect, alone or in combination with one or more of the first and second aspects, the indication indicates a quantity of truncations, and the quantity of truncations includes one or more of a quantity of event-level truncations or a quantity of beam-level truncations.

In a fourth aspect, alone or in combination with one or more of the first through third aspects, the indication has a first bit value to indicate a non-truncated MAC-CE measurement report and a second bit value to indicate the one or more truncated MAC-CE measurement reports.

In a fifth aspect, alone or in combination with one or more of the first through fourth aspects, process 300 includes transmitting a beam type indication for one or more beam types included in the one or more truncated MAC-CE measurement reports.

In a sixth aspect, alone or in combination with one or more of the first through fifth aspects, process 300 includes selecting, for inclusion in at least one of the one or more truncated MAC-CE measurement reports, one or more beam measurements or beam types, and the one or more beam measurements or beam types are selected in accordance with a priority of each of the one or more beam measurements or beam types, a quantity of beams that can be reported, or a physical uplink shared channel grant size.

In a seventh aspect, alone or in combination with one or more of the first through sixth aspects, at least one of the one or more truncated MAC-CE measurement reports includes one or more of an absolute RSRP value or a differential RSRP value for each of one or more selected beams.

In an eighth aspect, alone or in combination with one or more of the first through seventh aspects, the differential RSRP value includes one of a positive offset or a negative offset.

In a ninth aspect, alone or in combination with one or more of the first through eighth aspects, the one or more selected beams are ordered in at least one of the one or more truncated MAC-CE measurement reports by RSRP.

In a tenth aspect, alone or in combination with one or more of the first through ninth aspects, process 300 includes receiving an uplink grant for transmitting one or more pending measurement reports or beam results, wherein a quantity of the one or more beams or beam types selected for inclusion in the one or more MAC-CE measurement reports is based, at least in part, on a size of the uplink grant.

In an eleventh aspect, alone or in combination with one or more of the first through tenth aspects, process 300 includes transmitting a declaration indicating that all newly triggered beams have been reported.

In a twelfth aspect, alone or in combination with one or more of the first through eleventh aspects, the declaration is transmitted without transmitting at least one of the one or more truncated MAC-CE measurement reports.

In a thirteenth aspect, alone or in combination with one or more of the first through twelfth aspects, process 300 includes multiplexing transmission of a first truncated MAC-CE measurement report with transmission of a non-truncated MAC-CE measurement report or a second truncated MAC-CE measurement report.

In a fourteenth aspect, alone or in combination with one or more of the first through thirteenth aspects, process 300 includes discarding at least one of the one or more truncated MAC-CE measurement reports upon expiry of a timer.

In a fifteenth aspect, alone or in combination with one or more of the first through fourteenth aspects, process 300 includes updating one or more of a beam priority or a beam selection within a beam type.

Although FIG. 3 shows example blocks of process 300, in some aspects, process 300 may include additional blocks, fewer blocks, different blocks, or differently arranged blocks than those depicted in FIG. 3. Additionally, or alternatively, two or more of the blocks of process 300 may be performed in parallel.

FIG. 4 is a diagram illustrating an example process 400 performed, for example, at a network node or an apparatus of a network node. Example process 400 is an example where the apparatus or the network node (e.g., network node 110) performs operations associated with truncated event-triggered measurement report generation.

As shown in FIG. 4, in some aspects, process 400 may include receiving one or more truncated MAC-CE measurement reports (block 410). For example, the network node (e.g., using reception component 602 or communication manager 606, depicted in FIG. 6) may receive one or more truncated MAC-CE measurement reports, as described above.

As further shown in FIG. 4, in some aspects, process 400 may include receiving an indication of one or more pending measurement reports or one or more pending beam results as a result of an event-level truncation or a beam-level truncation (block 420). For example, the network node (e.g., using reception component 602 or communication manager 606, depicted in FIG. 6) may receive an indication of one or more pending measurement reports or one or more pending beam results as a result of an event-level truncation or a beam-level truncation, as described above.

Process 400 may include additional aspects, such as any single aspect or any combination of aspects described below or in connection with one or more other processes described elsewhere herein.

In a first aspect, receiving the indication includes receiving different MAC-CE indications for the one or more pending measurement reports and for the one or more pending beam results.

In a second aspect, alone or in combination with the first aspect, receiving the indication includes receiving a single indication for the one or more pending measurement reports and the one or more pending beam results.

In a third aspect, alone or in combination with one or more of the first and second aspects, the indication indicates a quantity of truncations, and the quantity of truncations includes one or more of a quantity of event-level truncations or a quantity of beam-level truncations.

In a fourth aspect, alone or in combination with one or more of the first through third aspects, the indication has a first bit value to indicate a non-truncated MAC-CE measurement report and a second bit value to indicate the one or more truncated MAC-CE measurement reports.

In a fifth aspect, alone or in combination with one or more of the first through fourth aspects, process 400 includes receiving a beam type indication for one or more beam types included in the one or more truncated MAC-CE measurement reports.

In a sixth aspect, alone or in combination with one or more of the first through fifth aspects, at least one of the one or more truncated MAC-CE measurement reports includes one or more of an absolute RSRP value or a differential RSRP value for each of one or more selected beams.

In a seventh aspect, alone or in combination with one or more of the first through sixth aspects, the differential RSRP value includes one of a positive offset or a negative offset.

In an eighth aspect, alone or in combination with one or more of the first through seventh aspects, process 400 includes transmitting an uplink grant for the UE to transmit one or more pending measurement reports or beam results.

In a ninth aspect, alone or in combination with one or more of the first through eighth aspects, process 400 includes receiving a declaration indicating that the UE has reported all newly triggered beams.

In a tenth aspect, alone or in combination with one or more of the first through ninth aspects, process 400 includes receiving a first truncated MAC-CE measurement report multiplex with a non-truncated MAC-CE measurement report or a second truncated MAC-CE measurement report.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication. The apparatus 500 may be a UE, or a UE may include the apparatus 500. In some aspects, the apparatus 500 includes a reception component 502, a transmission component 504, or a communication manager 506, which may be in communication with one another (for example, via one or more buses or one or more other components). In some aspects, the communication manager 506 is the communication manager 150 described in connection with FIG. 1. As shown, the apparatus 500 may communicate with another apparatus 508, such as a UE or a network node (such as a CU, a DU, an RU, or a base station), using the reception component 502 and the transmission component 504. The communication manager 506 may be included in, or implemented via, a processing system (for example, the processing system 140 described in connection with FIG. 1) of the UE.

In some aspects, the apparatus 500 may be configured to perform one or more operations described herein in connection with FIG. 2. Additionally, or alternatively, the apparatus 500 may be configured to perform one or more processes described herein, such as process 300 of FIG. 3. In some aspects, the apparatus 500 or one or more components shown in FIG. 5 may include one or more components of the UE described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 502 may receive communications, such as reference signals, control information, data communications, or a combination thereof, from the apparatus 508. The reception component 502 may provide received communications to one or more other components of the apparatus 500. In some aspects, the reception component 502 may perform signal processing on the received communications, and may provide the processed signals to the one or more other components of the apparatus 500. In some aspects, the reception component 502 may include one or more components of the UE described above in connection with FIG. 1, such as a radio, one or more RF chains, one or more transceivers, or one or more modems, each of which may in turn be coupled with one or more antennas of the UE.

The transmission component 504 may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications, and may transmit the processed signals to the apparatus 508. In some aspects, the transmission component 504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 504 may be co-located with the reception component 502.

The communication manager 506 may support operations of the reception component 502 or the transmission component 504. For example, the communication manager 506 may receive information associated with configuring reception of communications by the reception component 502 or transmission of communications by the transmission component 504. Additionally, or alternatively, the communication manager 506 may generate or provide control information to the reception component 502 or the transmission component 504 to control reception or transmission of communications.

The transmission component 504 may transmit one or more truncated MAC-CE measurement reports. The transmission component 504 may transmit, via a MAC-CE, an indication of one or more pending measurement reports or one or more pending beam results as a result of an event-level truncation or a beam-level truncation. The transmission component 504 may transmit a beam type indication for one or more beam types included in the one or more truncated MAC-CE measurement reports. The communication manager 506 may select, for inclusion in at least one of the one or more truncated MAC-CE measurement reports, one or more beam measurements or beam types, and the one or more beam measurements or beam types are selected in accordance with a priority of each of the one or more beam measurements or beam types, a quantity of beams that can be reported, or a physical uplink shared channel grant size. The reception component 502 may receive an uplink grant for transmitting one or more pending measurement reports or beam results. The transmission component 504 may transmit a declaration indicating that all newly triggered beams have been reported. The communication manager 506 may discard at least one of the one or more truncated MAC-CE measurement reports upon expiry of a timer. The communication manager 506 may update one or more of a beam priority or a beam selection within a beam type.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

FIG. 6 is a diagram of an example apparatus 600 for wireless communication. The apparatus 600 may be a network node, or a network node may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 155 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 145 described in connection with FIG. 1) of the network node.

In some aspects, the apparatus 600 may be configured to perform one or more operations described herein in connection with FIG. 2. Additionally, or alternatively, the apparatus 600 may be configured to perform one or more processes described herein, such as process 400 of FIG. 4. In some aspects, the apparatus 600 or one or more components shown in FIG. 6 may include one or more components of the network node described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the network node described above in connection with FIG. 1, such as a radio, one or more RF chains, one or more transceivers, or one or more modems, each of which may in turn be coupled with one or more antennas of the network node. In some aspects, the reception component 602 or the transmission component 604 may include or may be included in a network interface. The network interface may be configured to obtain or output signals for the apparatus 600 via one or more communications links, such as a backhaul link, a midhaul link, or a fronthaul link.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The reception component 602 may receive one or more truncated MAC-CE measurement reports. The reception component 602 may receive an indication of one or more pending measurement reports or one or more pending beam results as a result of an event-level truncation or a beam-level truncation. The reception component 602 may receive a beam type indication for one or more beam types included in the one or more truncated MAC-CE measurement reports. The transmission component 604 may transmit an uplink grant for the UE to transmit one or more pending measurement reports or beam results. The reception component 602 may receive a declaration indicating that the UE has reported all newly triggered beams. The reception component 602 may receive a first truncated MAC-CE measurement report multiplex with a non-truncated MAC-CE measurement report or a second truncated MAC-CE measurement report.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

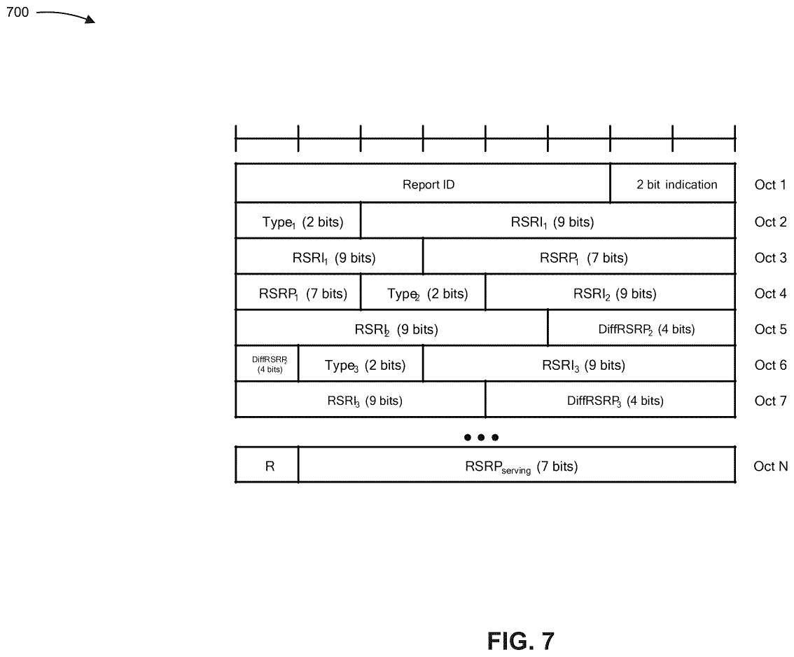

FIGS. 7-9 are diagrams illustrating examples 700, 800, and 900, respectively, associated with transmitting truncated MAC-CE measurement reports. In the examples 700, 800, and 900, a UE (e.g., UE 120) may communicate with a network node (e.g., network node 110).

As shown by example 700 of FIG. 7, the UE may transmit one or more truncated MAC-CE measurement reports. For example, the UE may generate the truncated MAC-CE measurement reports to communicate measurement data to the network node despite constraints in uplink resources. The truncated MAC-CE measurement reports may include a combination of absolute RSRP values and differential RSRP values for selected beams, as shown in FIG. 7. The report configuration may include a report identifier and a 2-bit indication that specifies the type of measurement being reported. In some aspects, the differential RSRP values may include both positive and negative offsets or may be configured to use negative-only offsets. In some aspects, the UE may transmit one or more truncated MAC-CE measurement reports that include absolute RSRP values for all beams without differential offsets, utilizing the full spectrum of available RSRP values. Alternatively or in addition, measurements included in the truncated MAC-CE measurement reports may be ordered to prioritize beams based on historical performance data or machine learning algorithms. Accordingly, the truncated MAC-CE measurement reports may include differential RSRP values with configurable thresholds for positive and negative offsets. For example, machine learning models may analyze past beam performance to predict future outcomes, and the beam reports can be adjusted to reflect the predictions of the machine learning models, thereby optimizing network communication strategies.

As further shown in FIG. 7, in some aspects, the UE may transmit, via a MAC-CE, an indication of one or more pending measurement reports or one or more pending beam results as a result of event-level truncation or beam-level truncation. For example, the UE may use separate indication fields within the MAC-CE to specify a pending status for different report types or may use a single indication to represent all pending reports. The indication may inform the network node of a need for further uplink resource allocations to complete measurement reporting. Additionally, or alternatively, instead of using a single indication for pending reports, the UE may employ a hierarchical indication structure to distinguish between high-priority and low-priority pending measurement reports or beam results. For example, the hierarchical structure may use a tiered indication fields that clearly identify which pending reports require immediate attention and which can be deferred, thus allowing for more efficient resource allocation by the network node.

In the example 700 of FIG. 7, the structure of the truncated MAC-CE measurement report is depicted, illustrating how information may be organized within each octet to efficiently convey measurement data and status indications. A first octet in the truncated MAC-CE measurement report may serve as a header, containing control information. The first octet may include a report configuration ID, which uniquely identifies the measurement report configuration being used. Additionally, the first octet may contain a 2-bit indication field that specifies a type of measurement being reported, such as whether the report includes absolute RSRP values, differential RSRP values, or a combination of both, among other examples. The two-bit indication may help the network node quickly interpret the type of data being conveyed without needing to parse the entire report. The second octet may be dedicated to the indication of pending measurement reports or beam results. The second octet may include separate fields for indicating pending status for different types of reports, such as event-level truncation or beam-level truncation. Alternatively, the second octet may use a single indication field to represent all pending reports, simplifying the signaling process. The information in the second octet may inform the network node of the necessity for further uplink resource allocation to complete the transmission of measurement data. Subsequent octets in the truncated MAC-CE measurement report may contain the actual measurement data. Each of the third through (N-1) (e.g., the second-to-last) octets may represent a specific beam measurement, including either an absolute RSRP value or a differential RSRP value. The differential RSRP values may include both positive and negative offsets or may be configured to use negative-only offsets, depending on the reporting configuration. The third through (N-1) octets may be organized to prioritize beams based on historical performance data or machine learning algorithms. The final octet (e.g., the Nth octet) in the truncated MAC-CE measurement report may include a beam type indication, specifying which types of beams are included in the report. The beam type information may help the network node understand the significance of the reported beams and manage network resources accordingly. In some aspects, the structure of the truncated MAC-CE measurement report, as depicted in the example 700 of FIG. 7, may convey measurement data and status indications efficiently, enabling the network node to make informed decisions about resource allocation and network management.

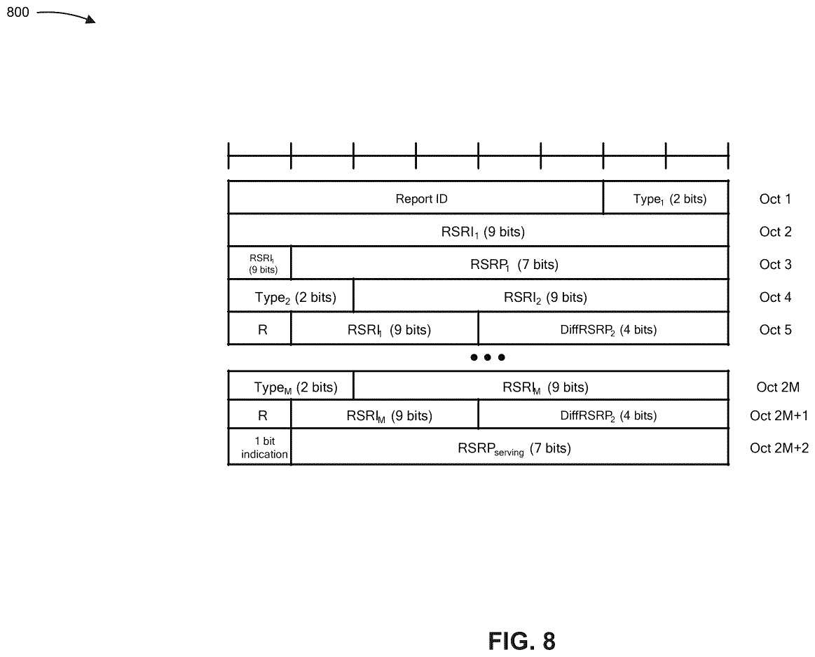

In some aspects, as shown by the example 800 of FIG. 8, the UE may transmit a beam type indication for one or more beam types included in the truncated MAC-CE measurement reports. For example, the UE may specify which types of beams, such as Type 1, Type 2, Type 3, and Type 4, are included in the truncated MAC-CE measurement report based on measurement priority. The beam type indication may assist the network node in understanding the significance of the reported beams and managing network resources accordingly. Alternatively or in addition, the UE may determine beam type inclusion based on dynamic environmental factors, such as network congestion levels or user mobility patterns, rather than fixed measurement priorities. For example, real-time analysis of network conditions may influence the selection of beam types reported, which allows adaptability in response to fluctuating environmental factors. Alternatively or in addition, the beam type indication transmitted by the UE may include a supplementary data field that provides contextual information about beam usage history or anticipated future performance. The contextual information may provide, to the network node, deeper insights into the strategic importance of each beam, enhancing decision-making for resource allocation.

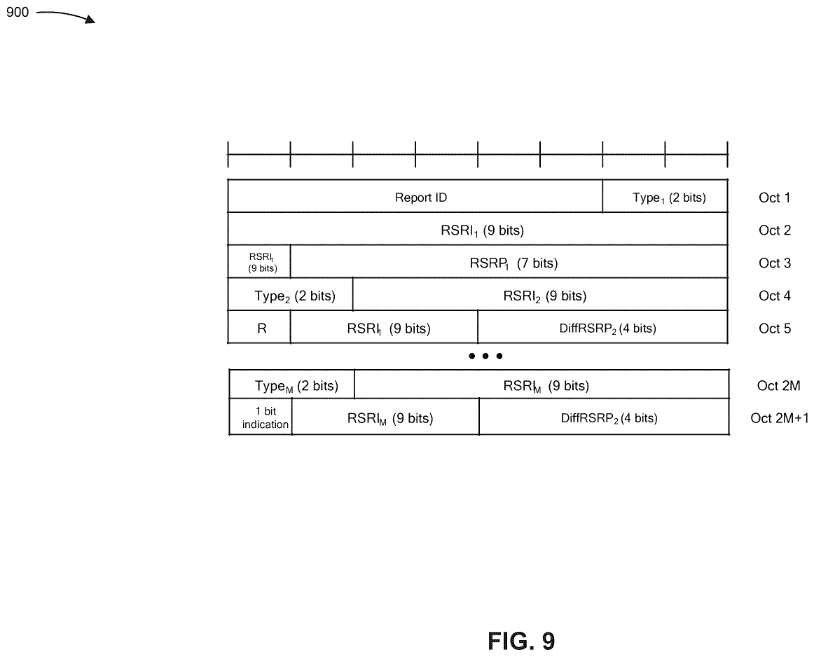

As shown by the examples 800 and 900 in FIGS. 8 and 9, respectively, the MAC-CE measurement reports may be structured to convey detailed information regarding beam measurements and associated metadata. In some aspects, each octet may serve a specific function, contributing to the overall reporting mechanism employed by the UE. An initial octet (e.g., octet 1) may include identifiers such as a report identifier and type fields, which may be used to categorize the measurement report and specify the nature of the data contained within the MAC-CE. The identifiers may help the network interpret the MAC-CE correctly and allocate resources accordingly. Subsequent octets (e.g., octets 2-5) may include RSRP index (RSRI) values or RSRP values for each beam. Additional octets (e.g., octets 2M to (2M+2) in FIG. 8 or octets 2M to (2M+1) in FIG. 9) may be dedicated to beam type categorization, utilizing a multi-bit Type field to classify beams into groups. The classification may aid in prioritizing beams based on significance to the communication process. The type field may be structured to accommodate various beam categories, such as Type 1, Type 2, Type 3, and Type 4, each represented by distinct codepoints. In some aspects, categorization helps the network efficiently manage beam data while optimizing resource allocation and communication quality. Additionally, in some aspects, one or more of the additional octets (e.g., octet (2M+2) in FIG. 8 or octet (2M+1) in FIG. 9) may include a 1-bit indication to signal the presence or absence of pending measurement reports or beam results due to event-level or beam-level truncations. In some aspects, the indication may inform the network of unsent data, prompting additional resource allocations to complete the transmission of remaining reports.

As indicated above, FIGS. 7-9 are provided as an example. Other examples may differ from what is described with respect to FIGS. 7-9.

The following provides an overview of some Aspects of the present disclosure:
Aspect 1: A method of wireless communication performed by a UE, comprising: selecting, for inclusion in one or more truncated medium access control (MAC) control element (MAC-CE) measurement reports, one or more beam measurements or beam types; transmitting the one or more truncated MAC-CE measurement reports that include the one or more beam measurements or beam types selected; and transmitting, via a MAC-CE, an indication of one or more pending measurement reports or one or more pending beam results.
Aspect 2: The method of Aspect 1, wherein transmitting the indication includes transmitting different MAC-CE indications for the one or more pending measurement reports and for the one or more pending beam results.
Aspect 3: The method of any of Aspects 1-2, wherein transmitting the indication includes transmitting a single indication for the one or more pending measurement reports and the one or more pending beam results.
Aspect 4: The method of any of Aspects 1-3, wherein the indication indicates a quantity of truncations.
Aspect 5: The method of Aspect 4, wherein the quantity of truncations includes one or more of a quantity of event-level truncations or a quantity of beam-level truncations.
Aspect 6: The method of any of Aspects 1-5, wherein the indication has a first bit value to indicate a non-truncated MAC-CE measurement report and a second bit value to indicate the one or more truncated MAC-CE measurement reports.
Aspect 7: The method of any of Aspects 1-6, further comprising transmitting a beam type indication for the one or more beam types included in the one or more truncated MAC-CE measurement reports.
Aspect 8: The method of any of Aspects 1-6, wherein the one or more beam measurements or beam types are selected in accordance with a priority of each of the one or more beam measurements or beam types, a quantity of beams that can be reported, or a physical uplink shared channel grant size.
Aspect 9: The method of any of Aspects 1-8, wherein at least one of the one or more truncated MAC-CE measurement reports includes one or more of an absolute RSRP value or a differential RSRP value for each of one or more selected beams.
Aspect 10: The method of Aspect 9, wherein the differential RSRP value includes one of a positive offset or a negative offset.
Aspect 11: The method of Aspect 9, wherein the one or more selected beams are ordered in at least one of the one or more truncated MAC-CE measurement reports by RSRP.
Aspect 12: The method of any of Aspects 1-11, further comprising receiving an uplink grant for transmitting one or more pending measurement reports or beam results, wherein a quantity of the one or more beams or beam types selected for inclusion in the one or more MAC-CE measurement reports is based, at least in part, on a size of the uplink grant.
Aspect 13: The method of any of Aspects 1-12, further comprising transmitting a declaration indicating that all newly triggered beams have been reported.
Aspect 14: The method of Aspect 13, wherein the declaration is transmitted without transmitting at least one of the one or more truncated MAC-CE measurement reports.
Aspect 15: The method of any of Aspects 1-14, further comprising multiplexing transmission of a first truncated MAC-CE measurement report with transmission of a non-truncated MAC-CE measurement report or a second truncated MAC-CE measurement report.
Aspect 16: The method of any of Aspects 1-15, further comprising discarding at least one of the one or more truncated MAC-CE measurement reports upon expiry of a timer.
Aspect 17: The method of any of Aspects 1-16, further comprising updating a beam priority or beam selection.
Aspect 18: A method of wireless communication performed by a network node, comprising: receiving, from a UE, one or more truncated MAC-CE measurement reports; and receiving, from the UE and via a MAC-CE, an indication of one or more pending measurement reports or one or more pending beam results as a result of an event-level truncation or a beam-level truncation.
Aspect 19: The method of Aspect 18, wherein receiving the indication includes receiving different MAC-CE indications for the one or more pending measurement reports and for the one or more pending beam results.
Aspect 20: The method of any of Aspects 18-19, wherein receiving the indication includes receiving a single indication for the one or more pending measurement reports and the one or more pending beam results.
Aspect 21: The method of any of Aspects 18-20, wherein the indication indicates a quantity of truncations, wherein the quantity of truncations includes one or more of a quantity of event-level truncations or a quantity of beam-level truncations.
Aspect 22: The method of any of Aspects 18-21, wherein the indication has a first bit value to indicate a non-truncated MAC-CE measurement report and a second bit value to indicate the one or more truncated MAC-CE measurement reports.
Aspect 23: The method of any of Aspects 18-22, further comprising receiving a beam type indication for one or more beam types included in the one or more truncated MAC-CE measurement reports.
Aspect 24: The method of any of Aspects 18-23, wherein at least one of the one or more truncated MAC-CE measurement reports includes one or more of an absolute RSRP value or a differential RSRP value for each of one or more selected beams.
Aspect 25: The method of Aspect 24, wherein the differential RSRP value includes one of a positive offset or a negative offset.
Aspect 26: The method of any of Aspects 18-25, further comprising transmitting an uplink grant for the UE to transmit one or more pending measurement reports or beam results.
Aspect 27: The method of any of Aspects 18-26, further comprising receiving a declaration indicating that the UE has reported all newly triggered beams.
Aspect 28: The method of any of Aspects 18-27, further comprising receiving a first truncated MAC-CE measurement report multiplex with a non-truncated MAC-CE measurement report or a second truncated MAC-CE measurement report.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.
Aspect 36: A device comprising a processing system that includes one or more processors and one or more code-storing memories coupled with the one or more processors, the processing system configured to cause the device to perform the method of one or more of Aspects 1-28.
Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more antennas; and
a processing system that includes one or more processors and one or more code-storing memories coupled with the one or more processors, the processing system configured to cause the UE to:
select, for inclusion in one or more truncated medium access control (MAC) control element (MAC-CE) measurement reports, one or more beam measurements or beam types;
transmit the one or more truncated MAC-CE measurement reports that include the one or more beam measurements or beam types selected; and
transmit, via a MAC-CE, an indication of one or more pending measurement reports or one or more pending beam.

2. The UE of claim 1, wherein the processing system, to cause the UE to transmit the indication, is configured to cause the UE to transmit different MAC-CE indications for the one or more pending measurement reports and for the one or more pending beam results.

3. The UE of claim 1, wherein the processing system, to cause the UE to transmit the indication, is configured to cause the UE to transmit a single indication for the one or more pending measurement reports and the one or more pending beam results.

4. The UE of claim 1, wherein the indication indicates a quantity of truncations.

5. The UE of claim 4, wherein the quantity of truncations includes one or more of a quantity of event-level truncations or a quantity of beam-level truncations.

6. The UE of claim 1, wherein the indication has a first bit value to indicate a non-truncated MAC-CE measurement report and a second bit value to indicate the one or more truncated MAC-CE measurement reports.

7. The UE of claim 1, wherein the processing system is configured to cause the UE to transmit a beam type indication for the one or more beam types included in the one or more truncated MAC-CE measurement reports.

8. The UE of claim 1, wherein the one or more beam measurements or beam types are selected in accordance with a priority of each of the one or more beam measurements or beam types, a quantity of beams that can be reported, or a physical uplink shared channel grant size.

9. The UE of claim 1, wherein at least one of the one or more truncated MAC-CE measurement reports includes one or more of an absolute reference signal received power (RSRP) value or a differential RSRP value for each of one or more selected beams.

10. The UE of claim 9, wherein the differential RSRP value includes one of a positive offset or a negative offset.

11. The UE of claim 9, wherein the one or more selected beams are ordered in at least one of the one or more truncated MAC-CE measurement reports by RSRP.

12. The UE of claim 1, wherein the processing system is configured to cause the UE to receive an uplink grant for transmitting one or more pending measurement reports or beam results,
wherein a quantity of the one or more beams or beam types selected for inclusion in the one or more MAC-CE measurement reports is based, at least in part, on a size of the uplink grant.

13. The UE of claim 1, wherein the processing system is configured to cause the UE to transmit a declaration indicating that all newly triggered beams have been reported.

14. The UE of claim 13, wherein the declaration is transmitted without transmitting at least one of the one or more truncated MAC-CE measurement reports.

15. The UE of claim 1, wherein the processing system is configured to cause the UE to multiplexing transmission of a first truncated MAC-CE measurement report with transmission of a non-truncated MAC-CE measurement report or a second truncated MAC-CE measurement report.

16. The UE of claim 1, wherein the processing system is configured to cause the UE to discard at least one of the one or more truncated MAC-CE measurement reports upon expiry of a timer.

17. A method of wireless communication performed by a user equipment (UE), comprising:
selecting, for inclusion in one or more truncated medium access control (MAC) control element (CE) (MAC-CE) measurement reports, one or more beam measurements or beam types;
transmitting the one or more truncated MAC-CE measurement reports that include the one or more beam measurements or beam types selected; and
transmitting, via a MAC-CE, an indication of one or more pending measurement reports or one or more pending beam results.

18. The method of claim 17, wherein the one or more beam measurements or beam types are selected in accordance with a priority of each of the one or more beam measurements or beam types, a quantity of beams that can be reported, or a physical uplink shared channel grant size.

19. The method of claim 17, further comprising updating one or more of a beam priority or a beam selection within a beam type.

20. A non-transitory computer-readable medium storing a set of instructions for wireless communication, the set of instructions comprising:
one or more instructions that, when executed by one or more processors of a user equipment (UE), cause the UE to:
select, for inclusion in one or more truncated medium access control (MAC) control element (CE) (MAC-CE) measurement reports, one or more beam measurements or beam types;
transmit the one or more truncated MAC-CE measurement reports that include the one or more beam measurements or beam types selected; and
transmit, via a MAC-CE, an indication of one or more pending measurement reports or one or more pending beam results.
